(19) United States
(12) Patent Application Publication
(10) Pub. No.: US 2023/0373529 A1
(43) Pub. Date: Nov. 23, 2023

(54) SAFETY FILTER FOR MACHINE LEARNING PLANNERS

(71) Applicant: Motional AD LLC, Boston, MA (US)

(72) Inventors: Momchil Tomov, Cambridge, MA (US); Eric Wolff, Zephyr Cove, NV (US); Sammy Omari, Pittsburgh, PA (US)

(21) Appl. No.: 18/320,899

(22) Filed: May 19, 2023

Related U.S. Application Data
(60) Provisional application No. 63/343,948, filed on May 19, 2022.

(51) Int. Cl. B60W 60/00

(52) U.S. Cl. CPC B60W 60/0015; B60W 60/0011; B60W 2554/80

(57) ABSTRACT

Provided are methods for a safety filter for machine learning planners. Example methods can include applying a plurality of safety parameters to a plurality of trajectories generated for an ego vehicle, determining whether the plurality of trajectories are unsafe based at least on application of the plurality of safety parameters to the plurality of trajectories, filtering a trajectory from the plurality of trajectories based at least on determining the trajectory is unsafe, and providing the remaining trajectories from the plurality of trajectories to a machine learning model trained to generate a score for selection of a selected trajectory for the vehicle from the remaining trajectories. Systems and computer program products are also provided.

### CROSS-REFERENCE TO RELATED APPLICATIONS

The present application claims priority to U.S. Provisional Application No. 63/343,948, filed May 19, 2022, and entitled, “Safety Filter for Machine Learning Planners,” the entirety of which is incorporated by reference herein.

### BACKGROUND

Generally, a vehicle moves along a trajectory. When obstacles, such as other vehicles, are detected along the trajectory, systems can be used to evaluate a number of trajectories and select an optimal trajectory for the vehicle. Consideration of an extremely large number of possible trajectories is computationally expensive, inefficient, and slow, particularly in a complex environment. Further, in some instances, the selected optimal trajectory can still be considered to be unsafe.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram of an example planning system;

FIG. 6 is a diagram of an example workflow for determining a trajectory for a vehicle;

FIGS. 7A-7C are diagrams showing an example implementation of a safety filter; and

FIG. 8 is a flowchart of a process for implementing a safety filter for a machine learning planner.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a safety filter for use with planners, such as machine learning-based planners that implement a machine learning model or other model to select a trajectory for a vehicle. The safety filter can identify generated trajectories that are considered to be unsafe. For example, the safety filter can filter out, from a plurality of generated trajectories, trajectories that are considered to be unsafe, such as when those trajectories fail a safety check. The safety check can involve applying a set of world assumptions used to predict the behavior of vehicles other than the monitored vehicle, a set of trajectory modifiers which are applied to the current trajectory of the monitored vehicle, and/or a set of safety checks which the modified vehicle trajectory passes.

By virtue of the implementation of systems, methods, and computer program products described herein, techniques for implementing a safety filter, such as for machine learning planners, improves the safety of optimal trajectories determined by the machine learning planners (or other model) by, for example, filtering out unsafe candidate trajectories for consideration by the machine learning planner. For example, the safety filter can filter out unsafe trajectories from the plurality of generated trajectories, rather than projecting the output trajectory to an ad-hoc trajectory set, which can be complicated and computationally expensive. Thus, the computational resources consumed by an autonomous system of an autonomous vehicle when planning operation of the autonomous vehicle through an environment can be reduced, by, for example, reducing the set of generated trajectories from which the machine learning planner selects an optimal trajectory for the vehicle. The safety filter can additionally and/or alternatively be lightweight, further reducing the computational resources required to select a safe and optimal trajectory for a vehicle. The safety filter can additionally and/or alternatively use a trajectory modifier to effectively implement a recursive safety analysis with minimal assumptions and checks, and/or without compromising comfort. This can result in improved safety in the optimal trajectory determined by the machine learning planner or other model.

Further, in some instances, machine learning planners often lack sufficient training data and training time, and/or have limited capacity that prevents such planners from always accurately selecting a safe trajectory for a vehicle. The safety filter can reduce the likelihood that an unsafe trajectory is ultimately selected for the vehicle, by, for example, filtering a set of generated trajectories to remove unsafe trajectories prior to the planner selecting an optimal trajectory. In some embodiments, the safety filter described herein can also incorporate expert knowledge about driving rules that the planner should always follow, further reducing the likelihood that an unsafe trajectory will be selected by the planner.

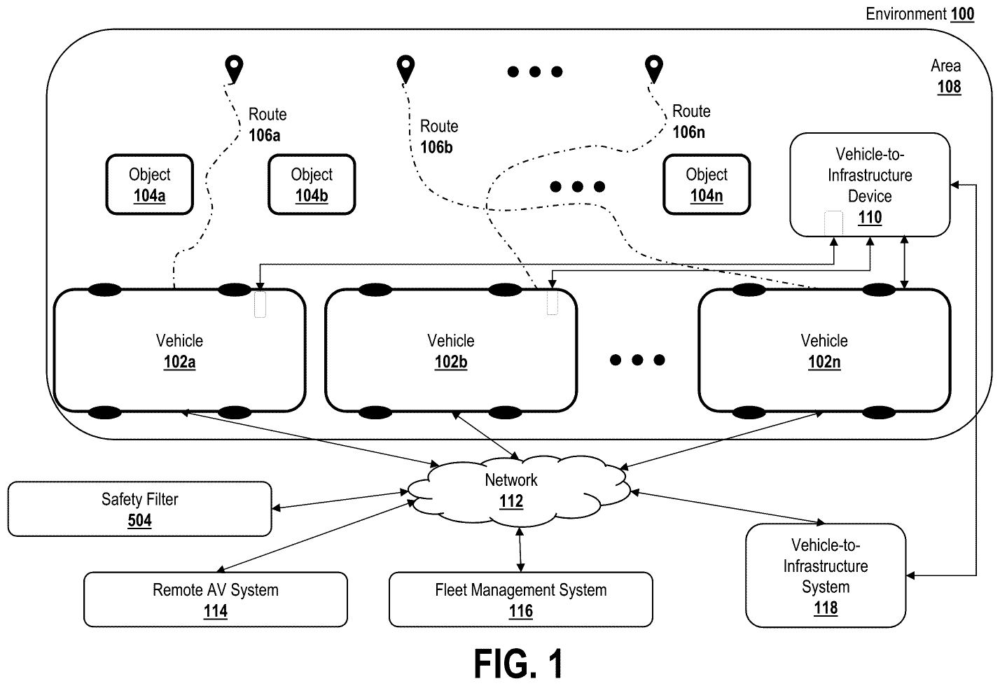

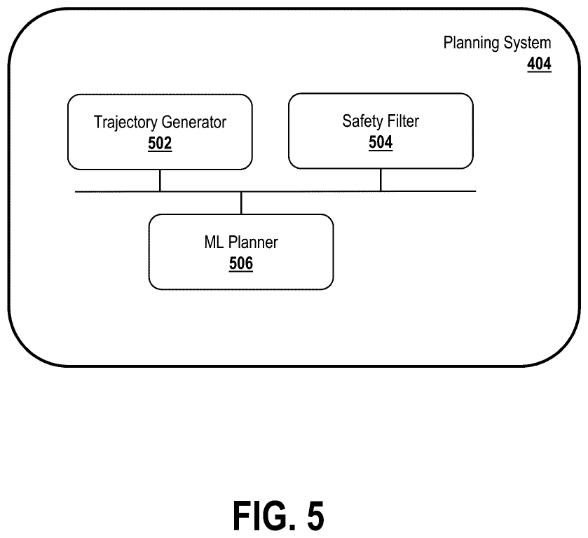

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, V2I system 118, and safety filter 504 (described in more detail with respect to FIGS. 5-9). Vehicles 102a-102n, vehicle-to-infrastructure (V2I) device 110, network 112, autonomous vehicle (AV) system 114, fleet management system 116, V2I system 118, and safety filter 504 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, V2I system 118, and safety filter 504 via wired connections, wireless connections, or a combination of wired or wireless connections.

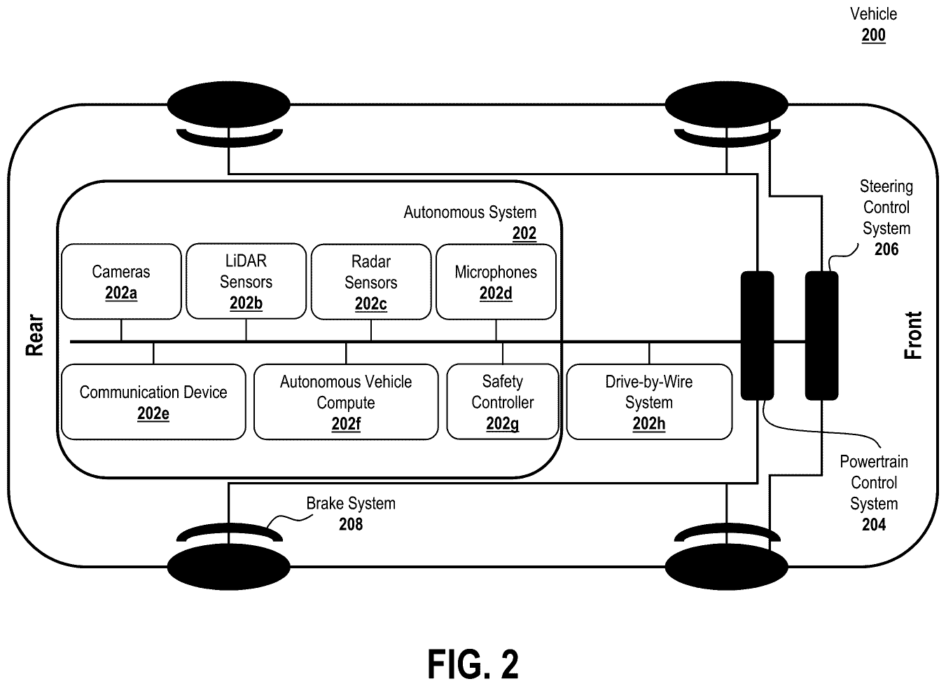

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, V2I system 118, and/or and safety filter 504 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operation or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

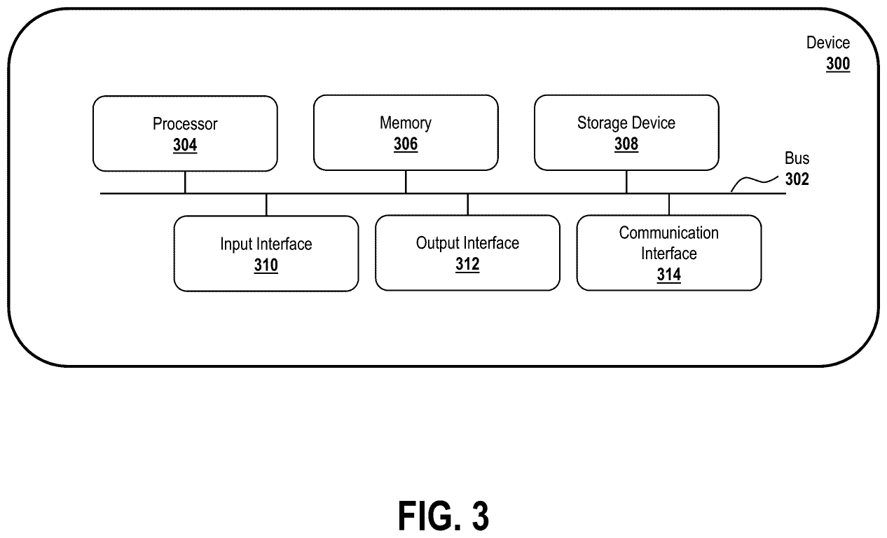

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charged-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

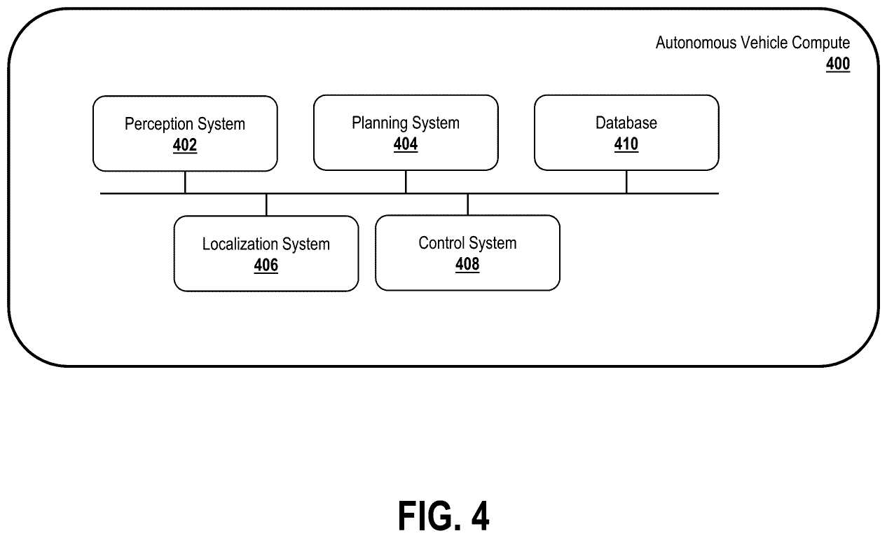

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406. Planning system 404 can additionally and/or alternatively receive information about the position of vehicle 102, pedestrians near vehicle 102 or along a trajectory of vehicle 102, the route of vehicle 102, other vehicles along the route or near vehicle 102, or the like.

In some embodiments, the planning system 404 may receive a plurality of candidate trajectories as an input and may provide as an output an optimal trajectory for the vehicle. Additionally and/or alternatively, the planning system 404 may generate a plurality of candidate trajectories and may provide as an output an optimal trajectory for the vehicle. Additionally and/or alternatively, planning system 404 may receive a filtered plurality of candidate trajectories generated by the safety filter. Planning system 404 may provide as the output the optimal trajectory based on the received set of filtered candidate trajectories.

FIG. 5 schematically depicts an example of planning system 404. As shown in FIG. 5, planning system 404 includes a trajectory generator 502, a safety filter 504, and a planner, such as a machine learning (ML) planner 506. Trajectory generator 502, safety filter 504, and/or ML planner 506 can be included in autonomous vehicle compute 400 (e.g., via planning system 404) or can be separately implemented as part of one or more systems described with respect to environment 100, and/or the like. Planning system 404 can generate the plurality of candidate trajectories (e.g., via trajectory generator 502), filters the plurality of candidate trajectories (e.g., via safety filter 504), and selects an optimal trajectory from the filtered plurality of candidate trajectories (e.g., via ML planner 506). While planning system 404 is depicted as including trajectory generator 502, safety filter 504, and ML planner 506, planning system 404 may only include the ML planner 506. In such embodiments, planning system 404 receives the filtered plurality of trajectories from separate safety filter 504 and selects the optimal trajectory for vehicle 102. In other embodiments, planning system 404 may only include safety filter 504 and ML planner 506. In such embodiments, planning system 404 receives the generated plurality of candidate trajectories from separate trajectory generator 502.

In some embodiments, ML planner 506 can be implemented as a machine learning model (e.g., at least one multilayer perceptron (MLP), at least one convolutional neural network (CNN), at least one recurrent neural network (RNN), at least one autoencoder, at least one transformer, at least one Inverse Reinforcement Learning (IRL) model, at least one propose-and-select model, at least one classification-based model or planner, and/or the like). ML planner 506 may include a machine learning model trained to generate a score for a candidate trajectory, such as a trajectory from the plurality of generated candidate trajectories and/or the filtered plurality of candidate trajectories. Based on the generated score, ML planner 506 or another portion of planning system 404 can select an optimal trajectory for vehicle 102. The machine learning model of ML planner 506 may be trained based on data from perception system 402, database 410, localization system 406, and/or control system 408, such as data associated with vehicle 102, a trajectory of vehicle 102, and an environment in which vehicle 102 is traveling.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like) as noted above. In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

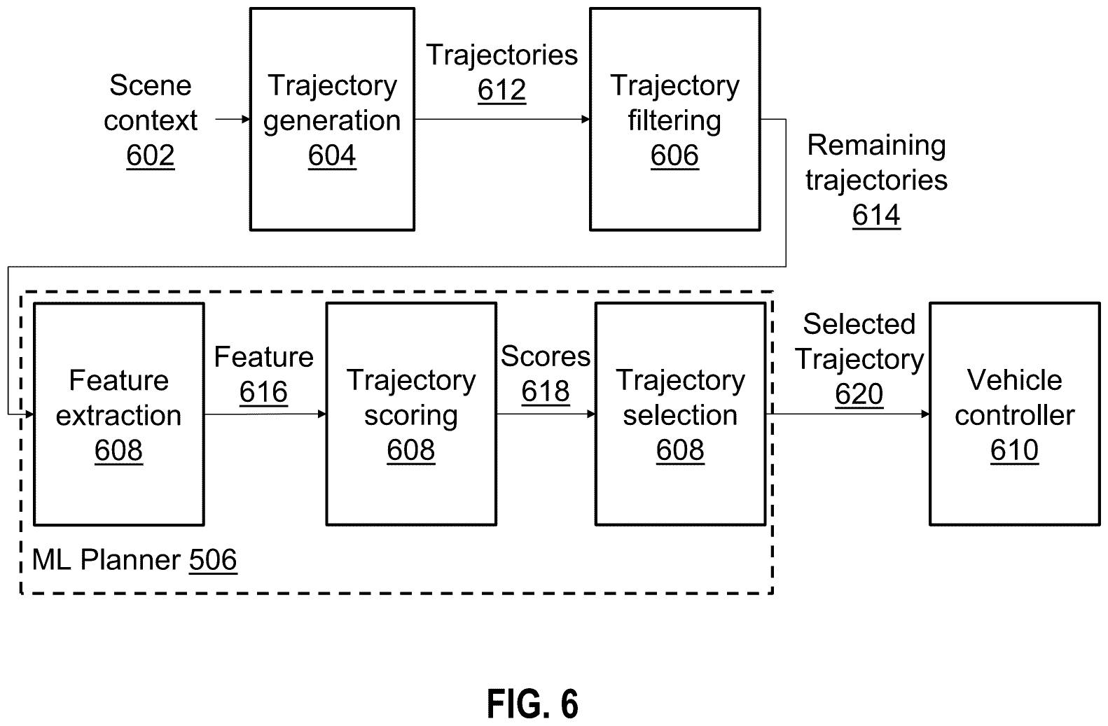

Referring now to FIGS. 6-9, illustrated are diagrams of implementations and/or aspects of a process for implementing safety filter 504 for machine learning planners, such as planning system 404. Referring to FIG. 6, illustrated is a flowchart of a process 600 for implementing safety filter 504. In some embodiments, one or more of the steps described with respect to process 600 are performed (e.g., completely, partially, and/or the like) by planning system 404, safety filter 504, trajectory generator 502, ML planner 506, and/or the like. In an embodiment, safety filter 504 is included in autonomous vehicle compute 400, one or more other systems described with respect to environment 100, and/or the like. Safety filter 504 can be implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware.

Additionally or alternatively, in some embodiments, one or more steps described with respect to a process 600 are performed (e.g., completely, partially, and/or the like) by another device or group of devices separate from or including safety filter 504 such as vehicles 102a-102n and/or vehicles 200, vehicle-to-infrastructure (V2I) device 110, network 112, remote autonomous vehicle (AV) system 114, fleet management system 116, V2I system 118, and/or planning system 404. In some embodiments, safety filter 404 includes, forms a part of, is coupled to, and/or uses vehicles 102a-102n and/or vehicles 200, objects 104a-104n, routes 106a-106n, area 108, vehicle-to-infrastructure (V2I) device 110, network 112, remote autonomous vehicle (AV) system 114, fleet management system 116, V2I system 118, and/or planning system 404. In some embodiments, safety filter 404 is the same as or similar to vehicles 102a-102n and/or vehicles 200, objects 104a-104n, routes 106a-106n, area 108, vehicle-to-infrastructure (V2I) device 110, network 112, remote autonomous vehicle (AV) system 114, fleet management system 116, V2I system 118, and/or planning system 404.

Referring to FIGS. 5 and 6, at 604, the trajectory generator 502 generates a plurality of trajectories 612 (also referred to herein as a plurality of candidate trajectories). The trajectory generator 502 generates the plurality of trajectories based on scene context 602. Scene context 602 may include data from perception system 402, database 410, localization system 406, and/or control system 408. Scene context 602 may be an encoding of the environment 10 (e.g., the scene) surrounding an ego vehicle (e.g., a vehicle being monitored, such as vehicles 102a-102n, vehicle 200, and/or the like). The encoding may include data associated with the ego vehicle (e.g., speed, acceleration, steering, a state of the vehicle, etc.), the route (e.g., at least one lane the ego vehicle should traverse) of the ego vehicle, other objects within the route or within the environment, non-ego vehicles or users (e.g., cars, bicyclists, pedestrians, etc.), a map (e.g., a high definition map in which dynamic objects such as lanes, lane boundaries, traffic light locations, pedestrian crosswalks, speed limits, and the like, are detected and tracked), a timestamp, and/or the like. The data may correspond to different time points (as indicated by the timestamp) for the ego vehicle.

Trajectory generator 502 generates the plurality of trajectories 612 based at least on scene context 602. The plurality of trajectories 612 can include one, two, three, four, five, ten, one hundred, one thousand, or more trajectories. The plurality of trajectories 612 include sequences of actions connecting states along which the ego vehicle can navigate. In other words, the plurality of trajectories 612 can be discrete sequences of future states of the ego vehicle, with an assumption that there is a fixed time step between all states. In some embodiments, the plurality of trajectories 612 represent trajectories that are dynamically feasible, satisfy control requirements (e.g., levels of continuity, minimum turn radius, minimum acceleration from a stop, etc.) of the ego vehicle, and/or are compliant with the map (e.g., stays on the road, etc.).

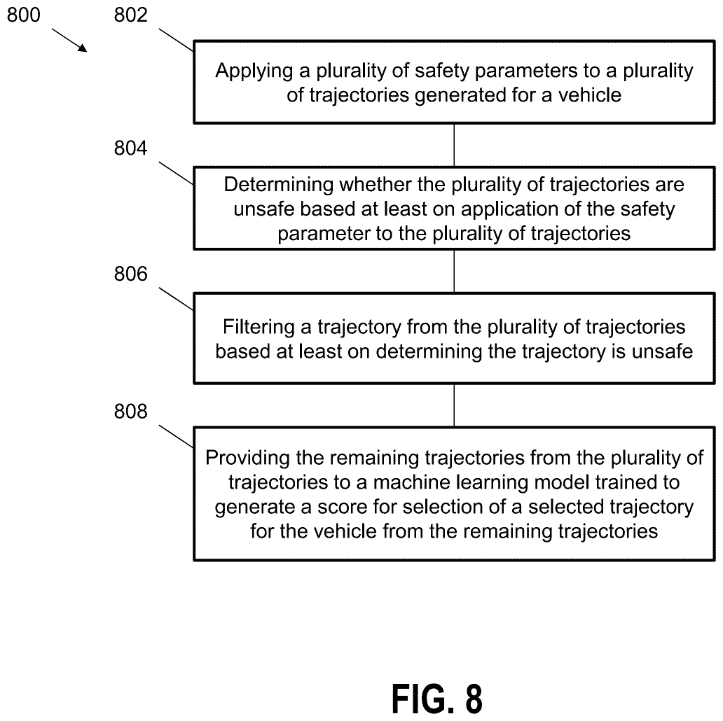

At 606, the safety filter 504 filters the plurality of trajectories 612. Referring now to FIG. 8, illustrated is a diagram of implementations and/or aspects of a process 800 for implementing safety filter 504 to filter the plurality of trajectories 612.

At 802, the safety filter 504 applies a plurality of safety parameters to plurality of trajectories 612 generated for the ego vehicle. The plurality of safety parameters includes a predefined assumption (e.g., at least one assumption, a plurality of assumptions, etc.) associated with all non-ego vehicles along the plurality of trajectories and a safety check (e.g., at least one safety check, a plurality of safety checks, etc.). While the plurality of safety parameters are described herein as being associated with (e.g., applied to) non-ego vehicles, the plurality of safety parameters may be associated with one or more non-ego tracks, such as vehicles, pedestrians, bicycles, or other obstacles along the trajectories.

The predefined assumption can include at least one assumption (e.g., a plurality of assumptions). The predefined assumption is used to simulate the behavior of the non-ego vehicles (or other tracks, such as bicycles, pedestrians, etc.) along the plurality of trajectories of the ego vehicle. The predefined assumption includes at least one of an assumption that the non-ego vehicles are stationary while the ego vehicle travels along the plurality of trajectories, an assumption that the non-ego vehicles perform a hard brake while the ego vehicle travels along the plurality of trajectories 612, an assumption that the non-ego vehicles maintain a current heading (e.g., direction) and velocity while the ego vehicle travels along the plurality of trajectories 612, an assumption the non-ego vehicles behind the ego vehicle are excluded, and an assumption that all the non-ego vehicles except for a non-ego vehicle directly in front of the ego vehicle are excluded.

The predefined assumption can be used to simulate the behavior of the non-ego vehicles for a filter horizon. The filter horizon can be predetermined and/or dynamically updated. The filter horizon is a time horizon indicating a length of time the plurality of trajectories 612 are evaluated by the safety filter 504. In other words, the plurality of trajectories 612 are evaluated for the duration of the filter horizon. The filter horizon can be one second, two seconds, three seconds, four seconds, five seconds, ten seconds, thirty seconds, or other ranges therebetween. As an example, if the time horizon is one second, the plurality of trajectories 612 are evaluated based on whether the ego vehicle passes the safety check after one second of following the plurality of trajectories 612.

The plurality of safety parameters can also include a trajectory modifier (e.g., at least one trajectory modifier, a plurality of trajectory modifiers, etc.). The trajectory modifier can be applied to the plurality of trajectories 612 of the ego vehicle prior to filtering the plurality of trajectories 612. For example, the trajectory modifier can modify the plurality of trajectories 612. The trajectory modifier can include at least one of the ego vehicle following the plurality of trajectories for a fixed period of time followed by a deceleration of the ego vehicle along the plurality of trajectories 612, the ego vehicle following the plurality of trajectories 612 for a predefined duration, the ego vehicle experiencing a predefined brake acceleration, and the ego vehicle experiencing a maximum jerk, and/or the like.

The safety check is applied to plurality of trajectories 612 and/or the modified plurality of trajectories (e.g., if the trajectory modifier is applied). The safety check is applied to the plurality of trajectories 612 and/or the modified plurality of trajectories based on the predefined assumption. The type of safety check can be predetermined and/or dynamically updated. The safety check includes at least one of determining, based at least on the predefined assumption, whether the ego vehicle experiences a collision while the ego vehicle travels along the plurality of trajectories and determining, based at least on the predefined assumption, whether the ego vehicle maintains at least a threshold distance behind a non-ego vehicle of the non-ego vehicles while the ego vehicle travels along the plurality of trajectories. Thus, the safety check can be used by the safety filter 504 to determine whether a particular trajectory of the plurality of trajectories 612 is unsafe and thus, should be filtered from the plurality of trajectories 612.

At 804, the safety filter 504 determines whether the plurality of trajectories 612 are unsafe based at least on application of the plurality of safety parameters to the plurality of trajectories 612. The safety filter 504 determines the plurality of trajectories 612 are unsafe when the ego vehicle following the plurality of trajectories 612 fails the safety check based at least on the predefined assumption. When the trajectory modifier is applied, the safety filter 504 determines the plurality of trajectories 612 are unsafe when the ego vehicle following the modified plurality of trajectories 612 fails the safety check based at least on the predefined assumption.

As an example, the safety filter 504 determines a trajectory from the plurality of trajectories 612 (or the modified plurality of trajectories) is unsafe when the safety filter determines the ego vehicle would experience a collision while the ego vehicle travels along the trajectory, based at least on the predefined assumption applied to the trajectory and/or the trajectory modifier applied to the trajectory. As another example, the safety filter 504 determines a trajectory from the plurality of trajectories 612 (or the modified plurality of trajectories) is unsafe when the ego vehicle fails to maintain at least a threshold distance (e.g., one meter, two meters, three meters, four meters, five meters, etc.) behind a non-ego vehicle of the non-ego vehicles while the ego vehicle travels along the trajectory, based at least on the predefined assumption applied to the trajectory and/or the trajectory modifier applied to the trajectory.

Additionally and/or alternatively, the safety filter 504 determines the plurality of trajectories 612 are safe based at least on application of the plurality of safety parameters to the plurality of trajectories 612. As an example, the safety filter 504 determines a trajectory from the plurality of trajectories 612 (or the modified plurality of trajectories) is safe when the safety filter determines the ego vehicle would not experience a collision while the ego vehicle travels along the trajectory, based at least on the predefined assumption applied to the trajectory and/or the trajectory modifier applied to the trajectory. As another example, the safety filter 504 determines a trajectory from the plurality of trajectories 612 (or the modified plurality of trajectories) is safe when the ego vehicle maintains at least a threshold distance behind a non-ego vehicle of the non-ego vehicles while the ego vehicle travels along the trajectory, based at least on the predefined assumption applied to the trajectory and/or the trajectory modifier applied to the trajectory. Other safety checks can be applied to the trajectory to determine whether the trajectory is safe or unsafe.

At 806, the safety filter 504 filters a trajectory from the plurality of trajectories 612 based at least on determining the trajectory is unsafe. Filtering the trajectory from the plurality of trajectories 612 includes removing the trajectory from the plurality of trajectories 612. After the safety filter 504 filters the trajectory from the plurality of trajectories 612, the remaining trajectories 614 (e.g., at least one remaining trajectory) from the plurality of trajectories 612 are considered to be safe such that the remaining trajectories 614 have passed the safety check given the predefined assumption and/or the trajectory modifier applied to the remaining trajectories 614. Additionally and/or alternatively, the safety filter 504 does not remove the trajectory from the plurality of trajectories 612 based at least on determining the trajectory is safe. The trajectory indicated as being safe is included in the remaining trajectories 614.

At 808, the safety filter 504 provides the remaining trajectories 614 from the plurality of trajectories 612 to ML planner 506. As noted, ML planner may include a machine learning model trained to generate a score for selection of a selected trajectory 620 for the ego vehicle from the remaining trajectories 614. In other words, the safety filter 504 provides the remaining trajectories 614 to the machine learning model. The machine learning model is at least one of an Inverse Reinforcement Learning model, a propose-and-select model, and a classification-based model.

In some examples, during filtering the trajectories 612, at 606, the safety filter 504 determines whether the ego vehicle has sufficient time headway. In this example, the filter horizon can be defined as one second (though other filter horizons can be used), the predefined assumption is defined as an assumption that the non-ego vehicles are stationary while the ego vehicle travels along a trajectory from the plurality of trajectories 612, and the safety check is defined as determining, based at least on the predefined assumption, whether the ego vehicle experiences a collision while the ego vehicle travels along the trajectory. This ensures that there are no collisions within the next one second, assuming all non-ego vehicles remain stationary. The safety filter 504 would determine that the trajectory is unsafe (and filter out the trajectory) when the ego vehicle collides with a non-ego vehicle while following the trajectory for one second or less, and based on the assumption that the non-ego vehicles are stationary. Alternatively, the safety filter 504 would determine that the trajectory is safe when the ego vehicle fails to collide with a non-ego vehicle while following the trajectory for one second or less, and based on the assumption that the non-ego vehicles are stationary.

In some examples, during filtering the trajectories 612, at 606, the safety filter 504 determines whether the ego vehicle has sufficient time to collision. In this example, the filter horizon can be defined as one second (though other filter horizons can be used), the predefined assumption is defined as an assumption that the non-ego vehicles maintain a current heading and velocity while the ego vehicle travels along a trajectory from the plurality of trajectories 612, and the safety check is defined as determining, based at least on the predefined assumption, whether the ego vehicle experiences a collision while the ego vehicle travels along the trajectory. This ensures that there are no collisions within the next one second, assuming all non-ego vehicles maintain a constant (e.g., current) velocity and/or heading. The safety filter 504 would determine that the trajectory is unsafe (and filter out the trajectory) when the ego vehicle collides with a non-ego vehicle while following the trajectory for one second or less, and based on the assumption that the non-ego vehicles maintain their current heading and velocity. Alternatively, the safety filter 504 would determine that the trajectory is safe when the ego vehicle fails to collide with a non-ego vehicle while following the trajectory for one second or less, and based on the assumption that the non-ego vehicles maintain their current heading and velocity.

This example may exclude slow trajectories from the plurality of trajectories 612 in which a non-ego vehicle is approaching the ego vehicle from behind the ego vehicle. In this scenario, an assumption that the non-ego vehicles behind the ego vehicle are excluded can be applied by the safety filter 504.

In some examples, during filtering the trajectories 612, at 606, the safety filter 504 determines whether the ego vehicle has sufficient headway. In this example, the filter horizon can be defined as three seconds (though other filter horizons can be used), the predefined assumption is defined as an assumption that the non-ego vehicles performs a hard brake while the ego vehicle travels along a trajectory from the plurality of trajectories 612, and the safety check is defined as determining, based at least on the predefined assumption, whether the ego vehicle experiences a collision while the ego vehicle travels along the trajectory. This ensures that there are no collisions within the next three seconds, assuming all non-ego vehicles perform a hard brake. Such examples can ensure that there is sufficient headway between the ego vehicle and the non-ego vehicles. The safety filter 504 would determine that the trajectory is unsafe (and filter out the trajectory) when the ego vehicle collides with a non-ego vehicle while following the trajectory for three seconds or less, and based on the assumption that the non-ego vehicles perform a hard brake. Alternatively, the safety filter 504 would determine that the trajectory is safe when the ego vehicle fails to collide with a non-ego vehicle while following the trajectory for three seconds or less, and based on the assumption that the non-ego vehicles perform a hard brake.

In some examples, a safety buffer can be added to help prevent the ego vehicle from experiencing a close call (but still avoiding a collision). For example, during filtering the trajectories 612, at 606, the safety filter 504 determines whether the ego vehicle has sufficient headway and a sufficient safety buffer. In this example, the filter horizon can be defined as three seconds (though other filter horizons can be used), the predefined assumption is defined as an assumption that the non-ego vehicles performs a hard brake while the ego vehicle travels along a trajectory from the plurality of trajectories 612, and the safety check is defined as determining, based at least on the predefined assumption, whether the ego vehicle maintains at least a threshold distance behind a non-ego vehicle (or track) of the non-ego vehicles while the ego vehicle travels along the trajectory. This ensures that the ego vehicle maintains a sufficient following distance in the next three seconds, assuming all non-ego vehicles perform a hard brake. In this example, the threshold distance can be set to three meters, although other threshold distances can be set. Such examples can ensure that there is sufficient headway between the ego vehicle and the non-ego vehicles. The safety filter 504 would determine that the trajectory is unsafe (and filter out the trajectory) when the ego vehicle fails to maintain the threshold distance from a non-ego vehicle while following the trajectory for three seconds or less, and based on the assumption that the non-ego vehicles perform a hard brake. Alternatively, the safety filter 504 would determine that the trajectory is safe when the ego vehicle maintains the threshold distance from a non-ego vehicle while following the trajectory for three seconds or less, and based on the assumption that the non-ego vehicles perform a hard brake.

In some examples, the trajectory modifier can be applied to a trajectory from the plurality of trajectories 612. This can help to recursively guarantee safety. For example, the trajectory modifier can be used to ensure recursive safety, such as when the ego vehicle follows a trajectory for some time (e.g., as defined by the trajectory modifier defining the fixed period the ego vehicle follows a non-ego vehicle) and then performs a firm brake (e.g., as defined by the trajectory modifier defining the deceleration of the ego vehicle), under certain comfort constraints (e.g., as defined by the trajectory modifier defining the maximum jerk of the ego vehicle).

As an example, the trajectory modifier can be used to ensure safety during a follow-then-brake scenario. For example, during filtering the trajectories 612, at 606, the safety filter 504 determines whether the ego vehicle has sufficient headway when the ego vehicle follows a non-ego vehicle that performs a hard break after some time. In this example, the filter horizon can be defined as six seconds (though other filter horizons can be used), the predefined assumption is defined as an assumption that the non-ego vehicles performs a hard brake while the ego vehicle travels along a trajectory from the plurality of trajectories 612, the trajectory modifier can be set as the ego vehicle following the trajectory for a fixed period followed by a deceleration along the trajectory, the ego vehicle following the trajectory for a predefined duration of one second (although other durations can be used), the ego vehicle experiencing a predefined brake acceleration of −2.5 m/s\hat{ }2, and the ego vehicle experiencing a maximum jerk of 3.5 m/s\hat{ }3, and the safety check is defined as determining, based at least on the predefined assumption, whether the ego vehicle maintains at least a threshold distance (e.g., 1.5 m) behind a non-ego vehicle (or track) of the non-ego vehicles while the ego vehicle travels along the trajectory. This ensures that the ego vehicle maintains a sufficient following distance if the non-ego vehicles perform a hard brake in the next one second, assuming the ego vehicle maintains a 1.5 m following distance in the next six seconds. Such examples can ensure that there is sufficient headway between the ego vehicle and the non-ego vehicles. The safety filter 504 would determine that the trajectory is unsafe (and filter out the trajectory) when the ego vehicle fails to maintain the threshold distance from a non-ego vehicle while following the trajectory for six seconds or less. Alternatively, the safety filter 504 would determine that the trajectory is safe when the ego vehicle maintains the threshold distance from a non-ego vehicle while following the trajectory for six seconds or less.

In some examples, the trajectory can be downsampled to speed up performance of the safety filter 504. The safety filter 504 can downsample the trajectory when the safety filter 504 evaluates the ego vehicle at only certain time points along the trajectory. In other words, the safety filter 504 evaluates the ego vehicle at only a subset of time points along the trajectory. This approach can lead to more efficient determining with respect to whether a trajectory is considered to be safe or unsafe, and thus, should be filtered from the plurality of trajectories 612. The downsampled trajectories can be defined. For example, the time points can be predetermined or otherwise defined as regular intervals or variable intervals. The time points can be defined in coarser increments. In other words, later times can be more spread out than earlier times since the ego vehicle is decelerating or already stopped, so it is unlikely that the trajectory will be unsafe during those later times.

As an example, during filtering the trajectories 612, at 606, the safety filter 504 determines whether the ego vehicle has sufficient headway when the ego vehicle follows a non-ego vehicle that performs a hard break after some time. In this example, the filter horizon can be defined as six seconds (though other filter horizons can be used), and the predefined assumption is defined as an assumption that the non-ego vehicles performs a hard brake while the ego vehicle travels along a trajectory from the plurality of trajectories 612. The predefined assumption can also be defined as an assumption that all non-ego vehicles except for a non-ego vehicle directly in front of the ego vehicle are excluded from consideration. This scenario can be used, such as during a cruise control operation. The trajectory modifier can be set as the ego vehicle following the trajectory for a fixed period followed by a deceleration along the trajectory, the ego vehicle following the trajectory for a predefined duration of one second (although other durations can be used), the ego vehicle experiencing a predefined brake acceleration of −2.5 m/s\hat{ }2, and the ego vehicle experiencing a maximum jerk of 3.5 m/s\hat{ }3, and the safety check is defined as determining, based at least on the predefined assumption, whether the ego vehicle maintains at least a threshold distance (e.g., 1.5 m) behind a non-ego vehicle (or track) of the non-ego vehicles while the ego vehicle travels along the trajectory. Further, the downsample times can be defined as a set including: [0.2 seconds, 0.4 seconds, 0.6 seconds, 0.8 seconds, 1.0 seconds, 1.4 seconds, 2.0 seconds, 2.4 seconds, 3.0 seconds, 4.0 seconds, 5.0 seconds, 6.0 seconds]. Here, the times are downsampled by a greater extent later on in the trajectory since the ego vehicle is decelerating or already stopped, so it is unlikely that the trajectory will be unsafe during those times. This ensures that the ego vehicle maintains a sufficient following distance if the non-ego vehicles perform a hard brake in the next one second, assuming the ego vehicle maintains a 1.5 m following distance in the next six seconds. Such examples can ensure that there is sufficient headway between the ego vehicle and the non-ego vehicles. The safety filter 504 would determine that the trajectory is unsafe (and filter out the trajectory) when the ego vehicle fails to maintain the threshold distance from a non-ego vehicle while following the trajectory for six seconds or less. Alternatively, the safety filter 504 would determine that the trajectory is safe when the ego vehicle maintains the threshold distance from a non-ego vehicle while following the trajectory for six seconds or less.

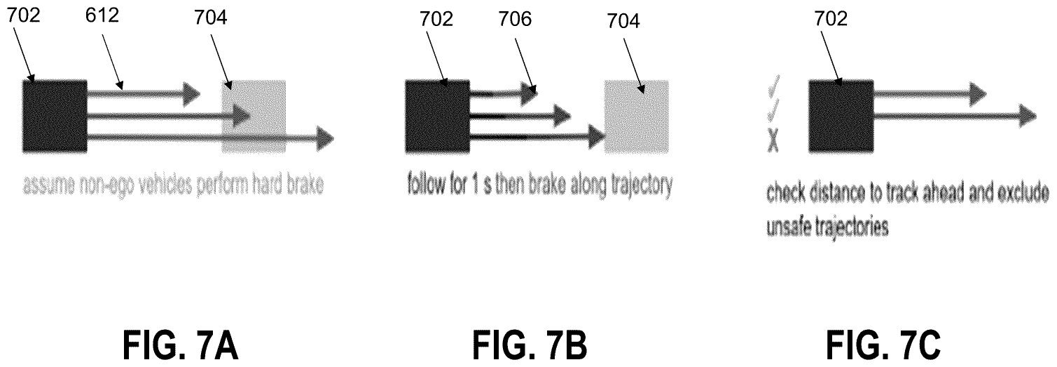

As another example, FIG. 7A shows ego vehicle 702 (e.g., the vehicles 102 and/or the vehicle 200), non-ego vehicle 704 (a vehicle on the roadway that is not the ego vehicle 702), and a plurality of trajectories 612. As noted above, filtering using the safety filter 504 can include applying an assumption (e.g., assume non-ego vehicles perform a hard brake) to non-ego vehicle 704 (see FIG. 7A). The process can include modifying the trajectory of the ego vehicle 702. For example, the trajectory can be modified so that the ego vehicle 702 follows the non-ego vehicle 704 for 1 second then brakes along the trajectory (see FIG. 7B). The process can also include filtering the unsafe trajectories, such as trajectories that include an unsafe distance (e.g., a distance within a threshold amount) between the ego vehicle 702 and the non-ego vehicle 704 after modification of the trajectory, to generate a filtered plurality of trajectories (see FIG. 7C).

In some embodiments, the safety filter 504 performs the trajectory filtering at 606 after ML planner 506 (e.g., using a machine learning model as described herein) has generated scores 618. In this example, the ML planner 506 can receive the plurality of trajectories 612 generated by the trajectory generator 502, at 604, and, based on the received plurality of trajectories 612, the ML planner 506 can determine the scores 618. A trajectory (e.g., a selected trajectory 620) can then be evaluated (e.g., using the process 900) by the safety filter 504 to determine whether the trajectory 620 is safe. If the trajectory is determined to be safe, the trajectory would be provided to the vehicle controller 610. If the trajectory is determined to be unsafe, the trajectory would be ignored or otherwise removed from the plurality of scored trajectories, and the trajectory with a next best score would be recursively evaluated by the safety filter 504 until a trajectory is found to be safe.

Referring again to FIG. 6, ML planner 506 receives the remaining (e.g., filtered) trajectories 614 from the plurality of trajectories 612. As noted, ML planner 506 can implement a machine learning model trained to generate a score used for selection of a selected trajectory 620 for the ego vehicle. ML planner 506 may additionally and/or alternatively select selected trajectory 620. For example, at 608, ML planner 506 (e.g., using the machine learning model) extracts at least one feature 616 from the remaining trajectories 614 and based at least on scene context 602 and remaining trajectories 614. Extracted features 616 can be encodings of data associated with the ego vehicle, the route of the ego vehicle, the map, the environment 10, and/or the like. Extracted features 616 can additionally and/or alternatively include a time-to-collision for the ego vehicle, adaptive cruise control information (e.g., a distance to track ahead, a speed of the ego vehicle, and the relative speed between the ego vehicle and the track ahead), a maximum jerk of the ego vehicle (e.g., taking into account the acceleration of the ego vehicle at a past, current, and planned trajectory), a maximum lateral acceleration along the trajectory, a concatenation of the particular trajectory and another (e.g., past trajectory), a speed limit, and/or the like.

At 608, ML planner 506 (e.g., using the trained machine learning model) generates a score 618 (e.g., a numeric score or other metric) for the plurality of remaining trajectories 614. ML planner 506 can generate score 618 for the plurality of remaining trajectories 614 based at least on extracted features 616. A value of the generated score 618 indicates whether or not the corresponding trajectory of the plurality of remaining trajectories 614 is an optimal trajectory. In some embodiments, a higher score indicates the trajectory is an optimal (e.g., more efficient) trajectory, while a lower score indicates the trajectory is a less optimal (e.g., less efficient) trajectory. In other embodiments, a lower score indicates the trajectory is an optimal (e.g., more efficient, safe, etc.) trajectory, while a higher score indicates the trajectory is a less optimal (e.g., less efficient, safe, etc.) trajectory.

At 610, ML planner 506 selects a selected trajectory 620 from the plurality of remaining trajectories 614. ML planner 506 selects selected trajectory 620 based at least on the generated score 618 for the plurality of remaining trajectories 614. In some examples, ML planner 506 ranks the plurality of remaining trajectories 614 based on the score. For example, ML planner 506 can rank the plurality of remaining trajectories 614 in ascending or descending order. ML planner 506 selects the selected trajectory 620 from the ranked plurality of remaining trajectories 614 based at least on the selected trajectory 620 having the highest score or lowest score, depending on the score that indicates the selected trajectory 620 as being the most optimal for the ego vehicle.

At 612, ML planner 506 provides (e.g., transmits) selected trajectory 620 to vehicle controller 610 of the ego vehicle. Vehicle controller 610 can include or be the same as control system 408. Vehicle controller 610 can control operation of the ego vehicle such that the ego vehicle operates according to the selected trajectory 620. For example, controller 610 can generate and/or transmit control signals to cause a powertrain control system (e.g., DBW system 202h, powertrain control system 204, and/or the like), a steering control system (e.g., steering control system 206), and/or a brake system (e.g., brake system 208) of the ego vehicle to operate according to selected trajectory 620. Accordingly, the ego vehicle can operate according to the selected trajectory 620, which is likely to be safe due at least in part to the safety filter 504.

According to some non-limiting embodiments or examples, provided is a system, comprising: at least one processor and at least one memory storing instructions thereon that, when executed by the at least one processor, result in operations comprising: applying a plurality of safety parameters to a plurality of trajectories generated for an ego vehicle, wherein the plurality of safety parameters includes a predefined assumption associated with all non-ego vehicles along the plurality of trajectories; and a safety check; determining whether the plurality of trajectories are unsafe based at least on application of the plurality of safety parameters to the plurality of trajectories; filtering a trajectory from the plurality of trajectories based at least on determining the trajectory is unsafe; and providing the remaining trajectories from the plurality of trajectories to a machine learning model trained to generate a score for selection of a selected trajectory for the vehicle from the remaining trajectories.

According to some non-limiting embodiments or examples, provided is at least one non-transitory computer-readable medium comprising one or more instructions that, when executed by at least one processor, cause the at least one processor to: apply a plurality of safety parameters to a plurality of trajectories generated for an ego vehicle, wherein the plurality of safety parameters includes a predefined assumption associated with all non-ego vehicles along the plurality of trajectories; and a safety check; determine whether the plurality of trajectories are unsafe based at least on application of the plurality of safety parameters to the plurality of trajectories; filter a trajectory from the plurality of trajectories based at least on determining the trajectory is unsafe; and provide the remaining trajectories from the plurality of trajectories to a machine learning model trained to generate a score for selection of a selected trajectory for the vehicle from the remaining trajectories.

According to some non-limiting embodiments or examples, provided is a method, comprising: applying a plurality of safety parameters to a plurality of trajectories generated for an ego vehicle, wherein the plurality of safety parameters includes a predefined assumption associated with all non-ego vehicles along the plurality of trajectories; and a safety check; determining whether the plurality of trajectories are unsafe based at least on application of the plurality of safety parameters to the plurality of trajectories; filtering a trajectory from the plurality of trajectories based at least on determining the trajectory is unsafe; and providing the remaining trajectories from the plurality of trajectories to a machine learning model trained to generate a score for selection of a selected trajectory for the vehicle from the remaining trajectories.

Further non-limiting aspects or embodiments are set forth in the following numbered clauses:

Clause 1: A system, comprising: at least one processor; and at least one non-transitory storage media storing instructions that, when executed by the at least one processor, cause the at least one processor to: apply a plurality of safety parameters to a plurality of trajectories generated for an ego vehicle, wherein the plurality of safety parameters includes a predefined assumption associated with all non-ego vehicles along the plurality of trajectories; and a safety check; determine whether the plurality of trajectories are unsafe based at least on application of the plurality of safety parameters to the plurality of trajectories; filter a trajectory from the plurality of trajectories based at least on determining the trajectory is unsafe; and provide the remaining trajectories from the plurality of trajectories to a machine learning model trained to generate a score for selection of a selected trajectory for the vehicle from the remaining trajectories.

Clause 2: The system of clause 1, wherein the plurality of trajectories are determined to be unsafe when the vehicle following the plurality of trajectories fails the safety check based at least on the predefined assumption.

Clause 3: The system of any one of clauses 1 to 2, wherein the safety check includes at least one of determining, based at least on the predefined assumption, whether the ego vehicle experiences a collision while the ego vehicle travels along the plurality of trajectories and determining, based at least on the predefined assumption, whether the ego vehicle maintains at least a threshold distance behind a non-ego vehicle of the non-ego vehicles while the ego vehicle travels along the plurality of trajectories.

Clause 4: The system of any one of clauses 1 to 3, wherein the predefined assumption includes at least one of an assumption that the non-ego vehicles are stationary while the ego vehicle travels along the plurality of trajectories, an assumption that the non-ego vehicles perform a hard brake while the ego vehicle travels along the plurality of trajectories, an assumption that the non-ego vehicles maintain a current heading and velocity while the ego vehicle travels along the plurality of trajectories, an assumption the non-ego vehicles behind the ego vehicle are excluded, and an assumption that all the non-ego vehicles except for a non-ego vehicle directly in front of the ego vehicle are excluded.

Clause 5: The system of any one of clauses 1 to 4, wherein the plurality of safety parameters further includes: a trajectory modifier modifying the plurality of trajectories prior to filtering the trajectory from the plurality of trajectories; and wherein the safety check is further performed based on modified plurality of trajectories.

Clause 6: The system of clause 5, wherein the trajectory modifier includes at least one of the ego vehicle following the plurality of trajectories for a fixed period followed by a deceleration along the plurality of trajectories, the ego vehicle following the plurality of trajectories for a predefined duration, the ego vehicle experiencing a predefined brake acceleration, and the ego vehicle experiencing a maximum jerk.

Clause 7: The system of any one of clauses 1 to 6, wherein the plurality of safety parameters further includes a predefined time horizon and/or a predefined downsampling of the time horizon.

Clause 8: The system of any one of clauses 1 to 7, wherein the predefined assumption includes a plurality of predefined assumptions, wherein the safety check includes a plurality of safety checks, and wherein the trajectory modifier includes a plurality of trajectory modifiers.

Clause 9: The system of any one of clauses 1 to 8, wherein the machine learning model is at least one of an Inverse Reinforcement Learning model, a propose-and-select model, and a classification-based model.

Clause 10: The system of any one of clauses 1 to 9, wherein the instructions, when executed by the at least one processor, further cause the at least one processor to at least one of receive the plurality of trajectories, and generate the plurality of trajectories.

Clause 11: A method, comprising: applying a plurality of safety parameters to a plurality of trajectories generated for an ego vehicle, wherein the plurality of safety parameters includes a predefined assumption associated with all non-ego vehicles along the plurality of trajectories; and a safety check; determining whether the plurality of trajectories are unsafe based at least on application of the plurality of safety parameters to the plurality of trajectories; filtering a trajectory from the plurality of trajectories based at least on determining the trajectory is unsafe; and providing the remaining trajectories from the plurality of trajectories to a machine learning model trained to generate a score for selection of a selected trajectory for the vehicle from the remaining trajectories.

Clause 12: The method of clause 11, wherein the plurality of trajectories are determined to be unsafe when the vehicle following the plurality of trajectories fails the safety check based at least on the predefined assumption.

Clause 13: The method of any one of clauses 11 to 12, wherein the safety check includes at least one of determining, based at least on the predefined assumption, whether the ego vehicle experiences a collision while the ego vehicle travels along the plurality of trajectories and determining, based at least on the predefined assumption, whether the ego vehicle maintains at least a threshold distance behind a non-ego vehicle of the non-ego vehicles while the ego vehicle travels along the plurality of trajectories.

Clause 14: The method of any one of clauses 11 to 13, wherein the predefined assumption includes at least one of an assumption that the non-ego vehicles are stationary while the ego vehicle travels along the plurality of trajectories, an assumption that the non-ego vehicles perform a hard brake while the ego vehicle travels along the plurality of trajectories, an assumption that the non-ego vehicles maintain a current heading and velocity while the ego vehicle travels along the plurality of trajectories, an assumption the non-ego vehicles behind the ego vehicle are excluded, and an assumption that all the non-ego vehicles except for a non-ego vehicle directly in front of the ego vehicle are excluded.

Clause 15: The method of any one of clauses 11 to 14, wherein the plurality of safety parameters further includes: a trajectory modifier modifying the plurality of trajectories prior to filtering the trajectory from the plurality of trajectories; and wherein the safety check is further performed based on modified plurality of trajectories.

Clause 16: The method of clause 15, wherein the trajectory modifier includes at least one of the ego vehicle following the plurality of trajectories for a fixed period followed by a deceleration along the plurality of trajectories, the ego vehicle following the plurality of trajectories for a predefined duration, the ego vehicle experiencing a predefined brake acceleration, and the ego vehicle experiencing a maximum jerk.

Clause 17: The method of any one of clauses 11 to 16, wherein the plurality of safety parameters further includes a predefined time horizon and/or a predefined downsampling of the time horizon.

Clause 18: The method of any one of clauses 11 to 17, wherein the predefined assumption includes a plurality of predefined assumptions, wherein the safety check includes a plurality of safety checks, and wherein the trajectory modifier includes a plurality of trajectory modifiers.

Clause 19: The method of any one of clauses 11 to 18, wherein the machine learning model is at least one of an Inverse Reinforcement Learning model, a propose-and-select model, and a classification-based model.

Clause 20: At least one non-transitory storage media storing instructions that, when executed by at least one processor, cause the at least one processor to: apply a plurality of safety parameters to a plurality of trajectories generated for an ego vehicle, wherein the plurality of safety parameters includes a predefined assumption associated with all non-ego vehicles along the plurality of trajectories; and a safety check; determine whether the plurality of trajectories are unsafe based at least on application of the plurality of safety parameters to the plurality of trajectories; filter a trajectory from the plurality of trajectories based at least on determining the trajectory is unsafe; and provide the remaining trajectories from the plurality of trajectories to a machine learning model trained to generate a score for selection of a selected trajectory for the vehicle from the remaining trajectories.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A system, comprising:
at least one processor; and
at least one non-transitory storage media storing instructions that, when executed by the at least one processor, cause the at least one processor to:
apply a plurality of safety parameters to a plurality of trajectories generated for an ego vehicle, wherein the plurality of safety parameters includes a predefined assumption associated with all non-ego vehicles along the plurality of trajectories; and a safety check;
determine whether the plurality of trajectories are unsafe based at least on application of the plurality of safety parameters to the plurality of trajectories;
filter a trajectory from the plurality of trajectories based at least on determining the trajectory is unsafe; and
provide the remaining trajectories from the plurality of trajectories to a machine learning model trained to generate a score for selection of a selected trajectory for the vehicle from the remaining trajectories.

2. The system of claim 1, wherein the plurality of trajectories are determined to be unsafe when the vehicle following the plurality of trajectories fails the safety check based at least on the predefined assumption.

3. The system of claim 1, wherein the safety check includes at least one of determining, based at least on the predefined assumption, whether the ego vehicle experiences a collision while the ego vehicle travels along the plurality of trajectories and determining, based at least on the predefined assumption, whether the ego vehicle maintains at least a threshold distance behind a non-ego vehicle of the non-ego vehicles while the ego vehicle travels along the plurality of trajectories.

4. The system of claim 1, wherein the predefined assumption includes at least one of an assumption that the non-ego vehicles are stationary while the ego vehicle travels along the plurality of trajectories, an assumption that the non-ego vehicles perform a hard brake while the ego vehicle travels along the plurality of trajectories, an assumption that the non-ego vehicles maintain a current heading and velocity while the ego vehicle travels along the plurality of trajectories, an assumption the non-ego vehicles behind the ego vehicle are excluded, and an assumption that all the non-ego vehicles except for a non-ego vehicle directly in front of the ego vehicle are excluded.

5. The system of claim 1, wherein the plurality of safety parameters further includes: a trajectory modifier modifying the plurality of trajectories prior to filtering the trajectory from the plurality of trajectories; and wherein the safety check is further performed based on modified plurality of trajectories.

6. The system of claim 5, wherein the trajectory modifier includes at least one of the ego vehicle following the plurality of trajectories for a fixed period followed by a deceleration along the plurality of trajectories, the ego vehicle following the plurality of trajectories for a predefined duration, the ego vehicle experiencing a predefined brake acceleration, and the ego vehicle experiencing a maximum jerk.

7. The system of claim 1, wherein the plurality of safety parameters further includes a predefined time horizon and/or a predefined downsampling of the time horizon.

8. The system of claim 1, wherein the predefined assumption includes a plurality of predefined assumptions, wherein the safety check includes a plurality of safety checks, and wherein the trajectory modifier includes a plurality of trajectory modifiers.

9. The system of claim 1, wherein the machine learning model is at least one of an Inverse Reinforcement Learning model, a propose-and-select model, and a classification-based model.

10. The system of claim 1, wherein the instructions, when executed by the at least one processor, further cause the at least one processor to at least one of receive the plurality of trajectories, and generate the plurality of trajectories.

11. A method, comprising:
applying a plurality of safety parameters to a plurality of trajectories generated for an ego vehicle, wherein the plurality of safety parameters includes a predefined assumption associated with all non-ego vehicles along the plurality of trajectories; and a safety check;
determining whether the plurality of trajectories are unsafe based at least on application of the plurality of safety parameters to the plurality of trajectories;
filtering a trajectory from the plurality of trajectories based at least on determining the trajectory is unsafe; and
providing the remaining trajectories from the plurality of trajectories to a machine learning model trained to generate a score for selection of a selected trajectory for the vehicle from the remaining trajectories.

12. The method of claim 11, wherein the plurality of trajectories are determined to be unsafe when the vehicle following the plurality of trajectories fails the safety check based at least on the predefined assumption.

13. The method of claim 11, wherein the safety check includes at least one of determining, based at least on the predefined assumption, whether the ego vehicle experiences a collision while the ego vehicle travels along the plurality of trajectories and determining, based at least on the predefined assumption, whether the ego vehicle maintains at least a threshold distance behind a non-ego vehicle of the non-ego vehicles while the ego vehicle travels along the plurality of trajectories.

14. The method of claim 11, wherein the predefined assumption includes at least one of an assumption that the non-ego vehicles are stationary while the ego vehicle travels along the plurality of trajectories, an assumption that the non-ego vehicles perform a hard brake while the ego vehicle travels along the plurality of trajectories, an assumption that the non-ego vehicles maintain a current heading and velocity while the ego vehicle travels along the plurality of trajectories, an assumption the non-ego vehicles behind the ego vehicle are excluded, and an assumption that all the non-ego vehicles except for a non-ego vehicle directly in front of the ego vehicle are excluded.

15. The method of claim 11, wherein the plurality of safety parameters further includes: a trajectory modifier modifying the plurality of trajectories prior to filtering the trajectory from the plurality of trajectories; and wherein the safety check is further performed based on modified plurality of trajectories.

16. The method of claim 15, wherein the trajectory modifier includes at least one of the ego vehicle following the plurality of trajectories for a fixed period followed by a deceleration along the plurality of trajectories, the ego vehicle following the plurality of trajectories for a predefined duration, the ego vehicle experiencing a predefined brake acceleration, and the ego vehicle experiencing a maximum jerk.

17. The method of claim 11, wherein the plurality of safety parameters further includes a predefined time horizon and/or a predefined downsampling of the time horizon.

18. The method of claim 11, wherein the predefined assumption includes a plurality of predefined assumptions, wherein the safety check includes a plurality of safety checks, and wherein the trajectory modifier includes a plurality of trajectory modifiers.

19. The method of claim 11, wherein the machine learning model is at least one of an Inverse Reinforcement Learning model, a propose-and-select model, and a classification-based model.

20. At least one non-transitory storage media storing instructions that, when executed by at least one processor, cause the at least one processor to:
apply a plurality of safety parameters to a plurality of trajectories generated for an ego vehicle, wherein the plurality of safety parameters includes a predefined assumption associated with all non-ego vehicles along the plurality of trajectories; and a safety check;
determine whether the plurality of trajectories are unsafe based at least on application of the plurality of safety parameters to the plurality of trajectories;
filter a trajectory from the plurality of trajectories based at least on determining the trajectory is unsafe; and
provide the remaining trajectories from the plurality of trajectories to a machine learning model trained to generate a score for selection of a selected trajectory for the vehicle from the remaining trajectories.
